(19) United States
(12) Patent Application Publication
(10) Pub. No.: US 2019/0123446 A1
(43) Pub. Date: Apr. 25, 2019

(54) Radio module

(71) Applicant: RASPBERRY PI (TRADING) LIMITED, Cambridge (GB)

(72) Inventor: Roger Thornton, Cambridge (GB)

(21) Appl. No.: 16/350,258

(22) Filed: Oct. 17, 2018

(30) Foreign Application Priority Data
Oct. 19, 2017 (GB) GB1717194.3

(51) Int. Cl. H01Q 13/16

(52) U.S. Cl. CPC H01Q 13/16

(57) ABSTRACT

A radio module comprising:
circuitry providing a data connection to receive and/or output a data signal and an RF converter to convert the data signal to and/or from an RF signal; and
a shield for shielding the circuitry from interference;
wherein the shield is connected to the circuitry and configured to function as an antenna to emit and/or receive a radio signal.

### PRIORITY CLAIM

This application claims priority to GB1717194.3, filed Oct. 19, 2017, the entire contents of which are fully incorporated herein by reference.

### FIELD

The present invention relates to radio modules, in particular self-contained radio modules that can be surface mounted to printed circuit boards.

### BACKGROUND

Various radio modules, for example to enable communication using WiFi™ and/or Bluetooth™ standards, are available. These radio modules are conveniently provided in the form of packages that can be mounted, e.g. using surface mount technology, to a PCB. Generally, such a radio module requires connections for power, ground, inputs, outputs and at least one antenna. The use of prepackaged radio modules greatly simplifies the design of devices such as single-board computers and micro-controllers whilst standardization and mass production reduces costs.

Single-board computers like the RaspberryPi™ have become very popular for educational and hobbyist use but have also found much wider use due to their low cost, small size and adaptability. Further reduction in the cost and/or size of single-board computers, micro-controllers and like devices is desirable.

### SUMMARY

Whilst pre-packaged radio modules can be made very small, basic physics sets limits on the size and locations of required antennas, dependent on the radio wavelengths employed. Often antennas can be formed by traces on the PCB, which reduces costs, but there are restrictions on the location of the antenna, such as needing to be at the edge of the board, which complicate design of the board. There is therefore a need for an improved antenna for use with pre-packaged radio modules.

According to an aspect of the invention, there is provided a radio module comprising:

circuitry providing a data connection to receive and/or output a data signal and an RF converter to convert the data signal to and/or from an RF signal; and

a shield for shielding the circuitry from interference;

wherein the shield is connected to the circuitry and configured to function as an antenna to emit and/or receive a radio signal.

In an embodiment, the shield is formed by a metal sheet.

In an embodiment, the shield has a cut-out to define an antenna part.

In an embodiment, the circuitry is contained in a surface-mount package.

In an embodiment, the shield is configured to surround the circuitry on all sides except a mounting side.

In an embodiment, the RF signal is based on a carrier wave having a frequency in the range of from 100 MHz to 100 GHz, desirably from 1 GHz to 10 GHz.

In an embodiment, the circuitry is configured to form a bi-directional communication link.

In an embodiment, the shield has a thickness in the range of from 0.05 mm to 1.0 mm, desirably 0.1 to 0.5 mm.

According to an aspect of the invention, there is provided a single-board computing device including a radio module as described above.

The present invention can therefore enable a reduction in the circuit board space required for a radio module and at the same time provide greater flexibility for the location of a radio module on a circuit board.

### BRIEF DESCRIPTION OF THE DRAWINGS

Embodiments of the invention will be described below with reference to the accompanying drawings, in which:

FIG. 1 is a schematic perspective view of a conventional circuit board and radio module in which the antenna is formed on the circuit board;

FIG. 2 is a view similar to FIG. 1 with a shield of the radio module removed;

FIG. 3 is a schematic perspective view of a conventional circuit board and radio module in which the antenna is formed on a substrate of the radio module;

FIG. 4 is a view similar to FIG. 3 with a shield of the radio module removed;

FIG. 5 is a schematic perspective view of a circuit board and radio module according to an embodiment of the invention;

FIG. 6 is a view similar to FIG. 5 with a shield of the radio module removed; and

FIG. 7 is a schematic diagram of a radio module according to the invention.

In the Figures, like parts are indicated by like references.

### DETAILED DESCRIPTION OF EXEMPLARY EMBODIMENTS

An embodiment of the present invention provides a radio module suitable for use with compact computing devices, such as single-board computers and micro-controllers, in which the functions of an antenna and a shield are combined into a single component. The shield can be made from a die-cut or pressed metal sheet and may function to protect the radio module from electromagnetic interference and/or physical damage.

Embodiments of the present invention can provide a number of advantages over conventional designs. The incorporation of the antenna into the shield reduces the area required on a circuit board. In addition, the invention provides greater flexibility as to the location of the radio module on a circuit board since it may not be necessary to position the antenna adjacent an edge of the circuit board. Furthermore, the present invention enables the design of a self-contained module that can be certified as compliant with electromagnetic interference regulations potentially avoiding the need for separate certification of products incorporating the radio module.

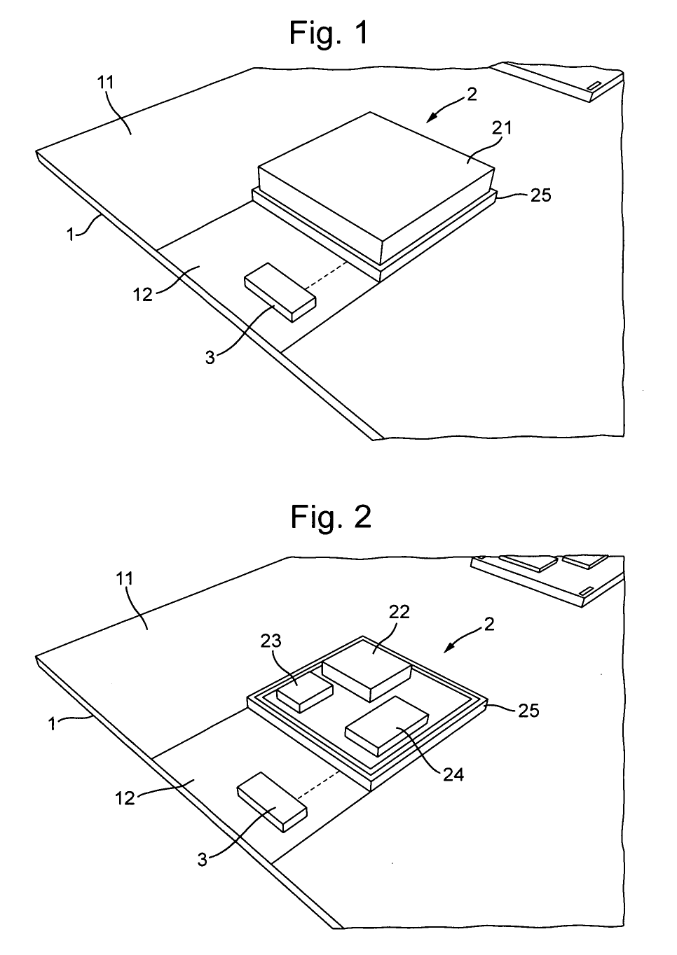

FIGS. 1 and 2 depict a conventional design of circuit board 1 on which is mounted a radio module 2. Both figures are perspective views; in FIG. 2 a shield 21 of the radio module 2 is removed to show internal components. Radio module 2 comprises integrated circuits 22, 23, 24 and other components mounted on a module substrate 25. Module substrate 25 includes connections between the integrated circuits 22-24 and to the circuit board 1. An antenna 3 for the radio module is provided on the circuit board 1 adjacent an edge thereof. It is necessary in this conventional design that the antenna 3 is near the edge of the board 1 so that it can radiate unimpeded by other components. Also, the ground plane 11 must be provided with a cut-out 12 around the antenna 3. Thus the area on the circuit board 1 taken up by the radio module and the antenna is increased and restrictions are imposed on their location that complicate the design of the circuit board and may prevent an optimal organisation of components. Shield 21 is designed to present ingress of external electromagnetic signals and is connected to a ground plane of the circuit board 1.

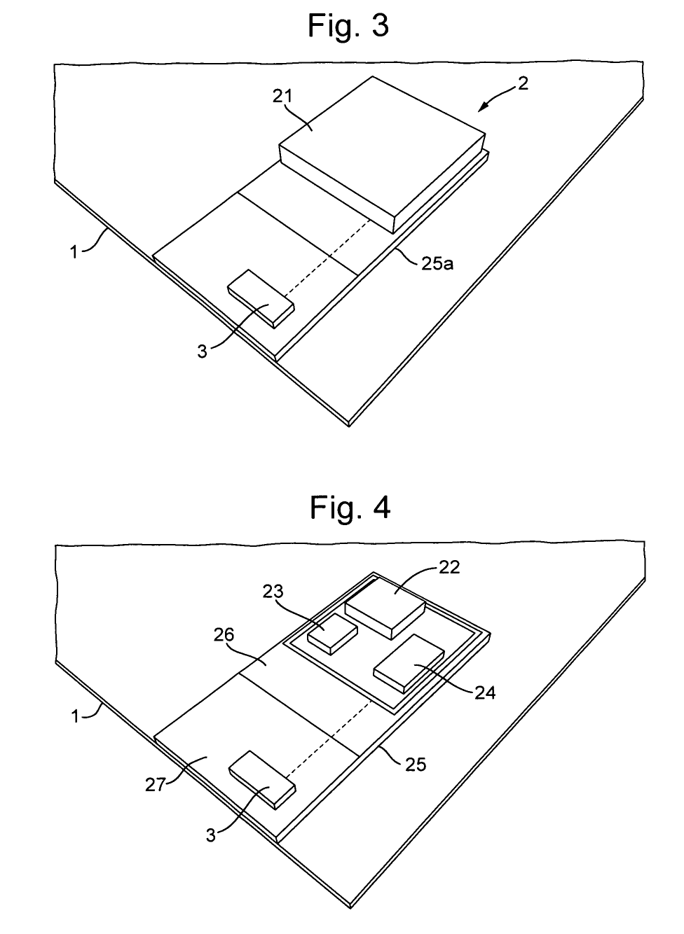

FIGS. 2 and 3 similarly depict another conventional design in which the antenna 3 is integrated into the package. The module substrate 25a extends beyond the shield 21 to provide an area outside the shield on which the antenna 21 is located. A ground plane 26 provided on the module substrate 25a does not extend to the area where the antenna 3 is provided. Although in this arrangement the assembly of the computing device is simplified, the inclusion of the antenna in the package in this way does not change the design constraints or reduce the area taken up.

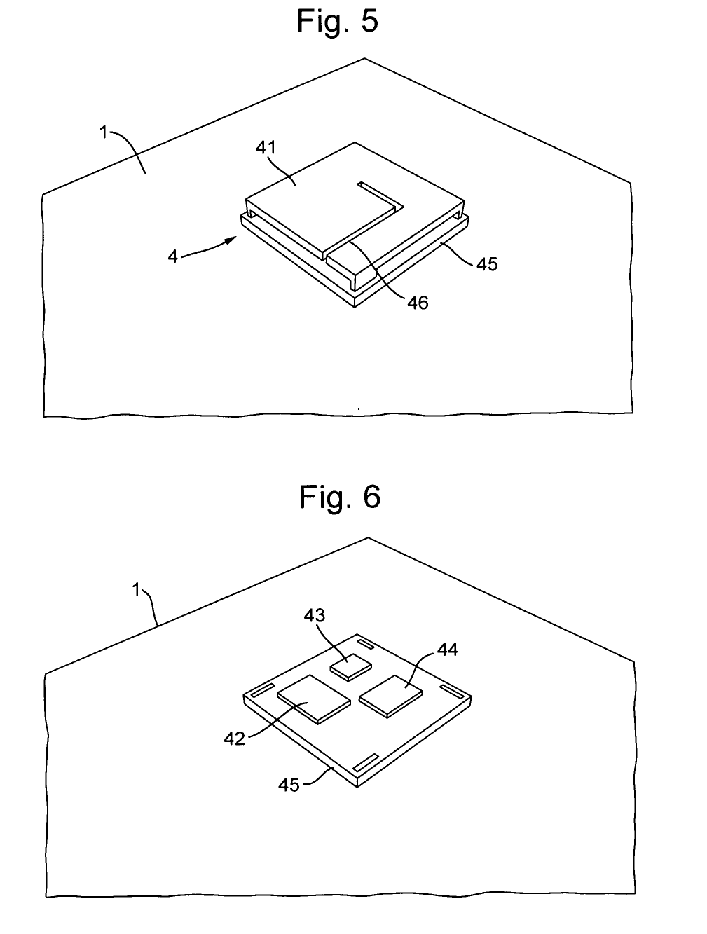

FIGS. 5 and 6 are schematic perspective views of an embodiment of the invention. In this embodiment, the radio module 4 comprises a substrate 45 on which are mounted integrated circuits 42, 43, 44 which perform the various functions of the radio module. A shield 41 performs the two functions of shielding the radio module, e.g. from physical intrusion and/or electromagnetic interference, and acting as an antenna for the radio module. Therefore, shield 41 is connected to an output unit of the radio module.

The radio module comprising shield and circuitry forms a single unit that can be mounted on a circuit board, e.g. a PCB, in a single operation. The circuitry is fixed to the shield prior to the mounting of the radio module on the circuit board. In other words, the shield and circuitry are an integral module. Desirably, the radio module is significantly smaller than the circuit board to which it is mounted.

Shield 41 can be manufactured from a thin metal plate, e.g. a ferrous metal, and may have a thickness in the range of from 0.05 mm to 1.0 mm, desirably 0.1 to 0.5 mm. This provides sufficient protection and physical strength whilst allowing the shield to be manufactured easily, e.g. by die-stamping. The shield surrounds the radio module on all sides except the side by which the radio module is mounted to the circuit board. In the case of a cuboid or box-like design, this means that the shield has five sides. The antenna part can be formed in any of the sides, but most often may be formed in the largest side. Cylindrical or can-shaped shields are also possible. Multiple antenna parts can be provided within the shield. Desirably the shield is formed from a single, integral body. However, it is possible that the shield can be formed by multiple parts which may or may not be electrically connected.

One or more cut-outs 46 are provided to control the radiative and/or receptive characteristics of the shield antenna 41. The efficiency of an antenna is related to its dimensions relative to the wavelength of the signal to be transmitted or received. For example a resonant antenna may be about, or slightly shorter than, ½ a wavelength. Cut-outs 46 may be arranged so that a part of the shield has the desired dimensions. Such a part may take the form of a strip of metal that is connected only at one end to the rest of the shield. The strip may be straight or bent as required to provide the necessary length.

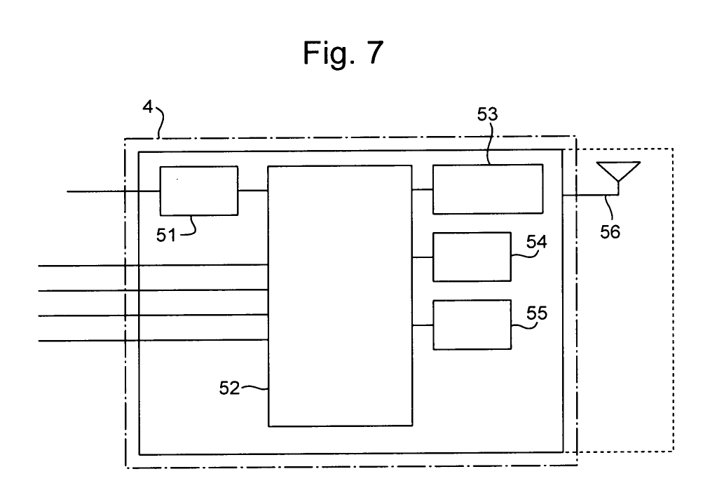

FIG. 7 is a schematic diagram of the radio module 4. In this embodiment the radio module comprises a crystal oscillator 51 which generates a signal of known frequency and is used to generate the carrier wave which is modulated to generate an output signal. A main radio ic 52 includes most of the functions of the radio module including, for example, power management, amplification and control. Other components not integrated into the radio ic 52 can include as necessary a diplexer 53, switch 54 and filters 55. A suitable connector or waveguide 56 connects to the shield antenna 41.

In an embodiment of the invention, the radio module is configured to provide communication under one or more standards such as WiFi™, Bluetooth™, Bluetooth SMART™, ANT+, GSM, UMTS, LTE, 4G, 5G, and/or to act as a receiver for services such as GPS, GLONASS, Galileo. To this end, the radio module may be configured to transmit and/or receive radio signals having a frequency in the range of from 100 MHz to 100 GHz, desirably from 1 GHz to 10 GHz.

Having described exemplary embodiments of the invention, it will be appreciated that modifications and variations of the described embodiments can be made. It will be appreciated that the radio module of the present invention can be used for both bi-directional (transmission and reception) as well as uni-directional applications. The teaching of the present invention can be applied to communication using a wide variety of protocols and wavelengths and all types of modulation. The invention is not to be limited by the foregoing description but only by the appended claims.

1. A radio module comprising:
circuitry providing a data connection to receive and/or output a data signal and an RF converter to convert the data signal to and/or from an RF signal; and
a shield for shielding the circuitry from interference;
wherein the shield is connected to the circuitry and configured to function as an antenna to emit and/or receive a radio signal.

2. A radio module according to claim 1 wherein the shield is formed by a metal sheet.

3. A radio module according to claim 1 wherein the shield has a cut-out to define an antenna part.

4. A radio module according to claim 1 wherein the circuitry is contained in a surface-mount package.

5. A radio module according to claim 1 wherein the shield is configured to surround the circuitry on all sides except a mounting side.

6. A radio module according to claim 1 wherein the RF signal is based on a carrier wave having a frequency in the range of from 100 MHz to 100 GHz, desirably from 1 GHz to 10 GHz.

7. A radio module according to claim 6 wherein the circuitry is configured to form a bi-directional communication link.

8. A radio module according to claim 1 wherein the shield has a thickness in the range of from 0.05 mm to 1.0 mm, desirably 0.1 to 0.5 mm.

9. A single-board computing device having a radio module according to claim 1.
